(19) United States
(12) Patent Application Publication
(10) Pub. No.: US 2026/0066563 A1
(43) Pub. Date: Mar. 5, 2026

(54) RECEPTACLE CONNECTOR

(71) Applicant: Japan Aviation Electronics Industry, Ltd., Tokyo (JP)

(72) Inventor: Osamu Hashiguchi, Tokyo (JP)

(73) Assignee: Japan Aviation Electronics Industry, Ltd., Tokyo (JP)

(21) Appl. No.: 19/272,219

(22) Filed: Jul. 17, 2025

(30) Foreign Application Priority Data
Aug. 29, 2024 (JP) 2024-147221

(51) Int. Cl. H01R 12/75; H01R 12/70

(52) U.S. Cl. CPC H01R 12/75; H01R 12/707

(57) ABSTRACT

Each receptacle contact includes a soldering part to be soldered to a connector mounting surface of a board, a fixed part to be fixed to a receptacle housing, and a spring part supported like a cantilever beam by the fixed part and elastically deformable in this recited order. The spring part includes a first contact part configured to come into contact with a plug connector. The plurality of receptacle contacts include a signal contact and a ground contact adjacent to each other. A spring part of the signal contacts and a spring part of the ground contact are elastically deformable independently of each other. The spring part of the ground contact further includes a second contact part that comes into contact with the ground plate when the connectors mate.

### INCORPORATION BY REFERENCE

This application is based upon and claims the benefit of priority from Japanese patent application No. 2024-147221, filed on August 29, 2024, the disclosure of which is incorporated herein in its entirety by reference.

### BACKGROUND

The present invention relates to a receptacle connector.

Patent Literature 1 discloses a connector for high-speed transmission of about 2.0 Gbps. As shown in FIG. 14 of the present application, the connector includes a plurality of contacts 100 mounted on an insulative housing.

Each contact 100 includes a ground terminal 101 that is held at a ground potential, an insulating layer 102, a signal line 103, and two ground lines 104.

The ground terminal 101 includes a base part 105 in a flat-plate shape, three extension parts 106 extending in parallel with one another from one end of the base part 105, and three extension parts 107 extending in parallel with one another from the other end of the base part 105.

The three extension parts 106 include an extension part 106A located in the middle and two extension parts 106B located on both sides thereof.

On the extension part 106A, the signal line 103 is formed with the insulating layer 102 interposed therebetween. On the two extension parts 106B, the two ground lines 104 are formed, respectively, with the insulating layer 102 interposed therebetween.

The signal line 103 and the extension part 106A constitute a microstrip line.

[Patent Literature 1] Japanese Unexamined Patent Application Publication No. 2015-210886

### SUMMARY

In the structure of Patent Literature 1, since the three extension parts 106 are formed in a comb shape, the extension part 106A is electrically connected with a ground of a plug connector through the base part 105 and the extension part 106B. Thus, although the signal line 103 and the extension part 106A constitute a microstrip line in form, there is room for improvement in terms of high-frequency performance.

One approach to improve the high-frequency performance is replacing the three extension parts 106 with an extension part in a flat-plate shape, just like the base part 105, in the structure of the above-described Patent Literature 1. In this case, however, the signal line 103 and the two ground lines 104 are not elastically deformable independently of each other, which would significantly degrade the contact reliability.

An object of the present disclosure is to provide a technique that achieves the contact reliability and the high-frequency performance at the same time.

Provided is a receptacle connector to be mounted on a board, including a plurality of contacts extending parallel to each other; a ground plate disposed opposed to the plurality of contacts; and a housing that accommodates the plurality of contacts and the ground plate, wherein each of the plurality of contacts includes, in the following recited order, a soldering part to be soldered to the board; a fixed part to be fixed to the housing; and a spring part supported like a cantilever beam by the fixed part and elastically deformable, the spring part includes a first contact part configured to come into contact with a plug connector, the plurality of contacts include a signal contact and a ground contact adjacent to each other, the spring part of the signal contact and the spring part of the ground contact are elastically deformable independently of each other, and the spring part of the ground contact further includes a second contact part that comes into contact with the ground plate when the connectors mate or is in contact with the ground plate already before the connectors mate.

Provided is a receptacle connector to be mounted on a board, including a plurality of contacts extending parallel to each other; a ground plate disposed opposed to the plurality of contacts; a rigid board disposed between the plurality of contacts and the ground plate; and a housing that accommodates the plurality of contacts, the ground plate, and the rigid board, wherein the rigid board includes a contact surface facing the plurality of contacts and a ground surface facing the ground plate, the ground plate is formed as a solid pattern on the ground surface, each of the plurality of contacts includes, in the following recited order, a soldering part to be soldered to the board; a fixed part to be fixed to the rigid board; and a spring part supported like a cantilever beam by the fixed part and elastically deformable, the spring part includes a first contact part configured to come into contact with a plug connector, the plurality of contacts include a signal contact and a ground contact adjacent to each other, the spring part of the signal contact and the spring part of the ground contact are elastically deformable independently of each other, the spring part of the ground contact further includes a second contact part that comes into contact with a contact pad formed on the contact surface when the connectors mate or is in contact with the contact pad already before the connectors mate, and the contact pad is electrically connected with the ground plate via a through-hole.

According to the present disclosure, the contact reliability and the high-frequency performance are achieved at the same time.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of a connector assembly when connectors mate (first embodiment);

FIG. 2 is a perspective view of the connector assembly before connectors mate (first embodiment);

FIG. 3 is a perspective view of a plug connector (first embodiment);

FIG. 4 is an exploded perspective view of a receptacle connector (first embodiment);

FIG. 5 is an end view of the receptacle connector (first embodiment);

FIG. 6 is an end view of the receptacle connector (first embodiment);

FIG. 7 is a perspective view of a contact assembly of a receptacle connector (second embodiment);

FIG. 8 is a perspective view of a contact assembly of a receptacle connector (third embodiment);

FIG. 9 is an end view of the contact assembly of the receptacle connector (third embodiment);

FIG. 10 is a perspective view of a contact assembly of a receptacle connector (fourth embodiment);

FIG. 11 is a perspective view of the contact assembly of the receptacle connector (fourth embodiment);

FIG. 12 is an end view of the contact assembly of the receptacle connector (fourth embodiment);

FIG. 13 is an end view of the contact assembly of the receptacle connector (fourth embodiment); and

FIG. 14 is a view showing a simplified version of FIG. 4 of Patent Literature 1.

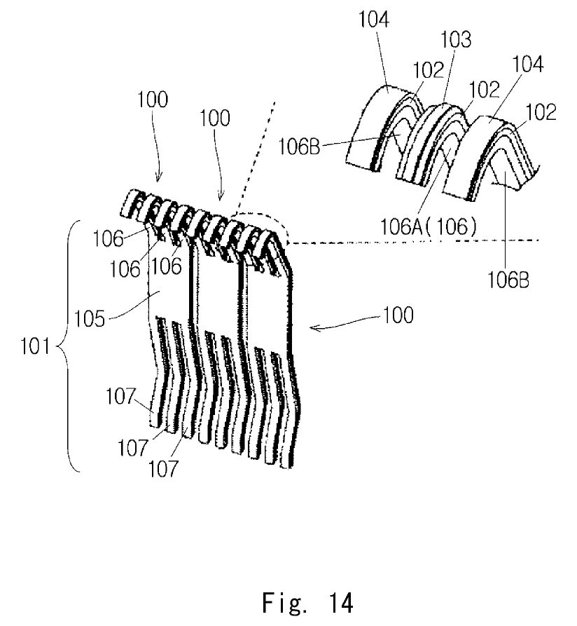

### DESCRIPTION OF EMBODIMENTS

Although the present disclosure will be described hereinafter through embodiments, the disclosure defined by the scope of claims is not limited to the following embodiments. Further, not all of the elements described in the embodiments are essential as a solution to problem. The following description and the drawings are appropriately shortened and simplified to clarify the explanation. In the drawings, the identical reference symbols denote identical structural elements and the redundant explanation thereof is omitted according to need.

Although the following embodiments are divided into a plurality of sections or embodiments when needed for the sake of convenience, the divided sections or embodiments are not irrelevant to one another, but one section or embodiment is a modification, detail, or supplementary explanation of a part or all of the other unless otherwise particularly stated. When reference is made to the number of elements and so on (including the number of pieces, numerical value, quantity, range, etc.) in the following embodiments, it is not limited to a specific number, but may be greater than or less than or equal to the specific number unless otherwise particularly stated or unless definitely limited to the specific number in principle.

Further, in the following embodiments, elements (including operation steps, etc.) are not always essential unless otherwise particularly stated or considered to be definitely essential in principle. Similarly, when reference is made to the shapes, positional relations and so on of the elements or the like in the following embodiments, they include ones that are substantially approximate or similar to their shapes and so on unless otherwise particularly stated and considered to be definitely not applicable in principle. The same applies to the above-described number and so on (including the number of pieces, numerical value, quantity, range, etc.).

### (First Embodiment)

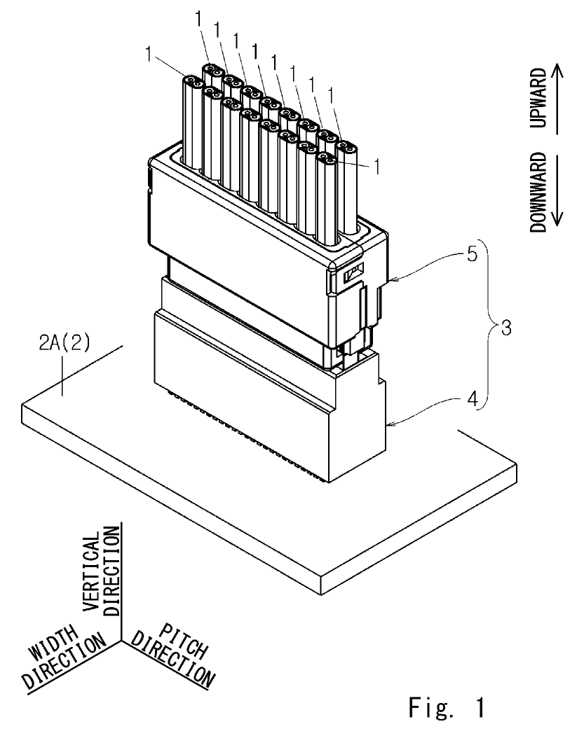

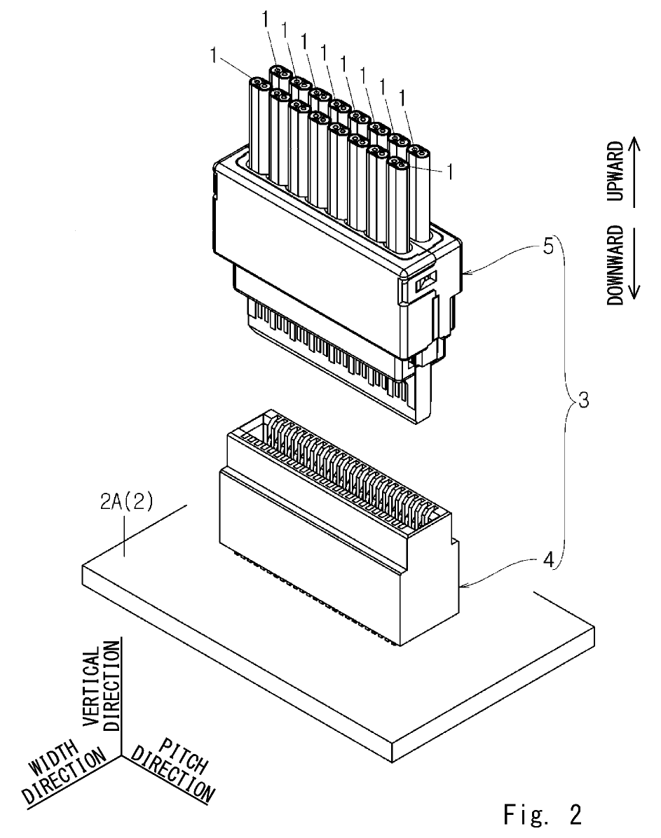

A first embodiment of the present disclosure will be described hereinafter with reference to FIGS. 1 to 6. FIGS. 1 and 2 show a connector assembly 3 that mechanically and electrically connects a plurality of cables 1 to a board 2. The connector assembly 3 includes a receptacle connector 4 to be surface-mounted on a connector mounting surface 2A of the board 2, and a plug connector 5 to be placed at ends of the plurality of cables 1.

### (Plug Connector 5)

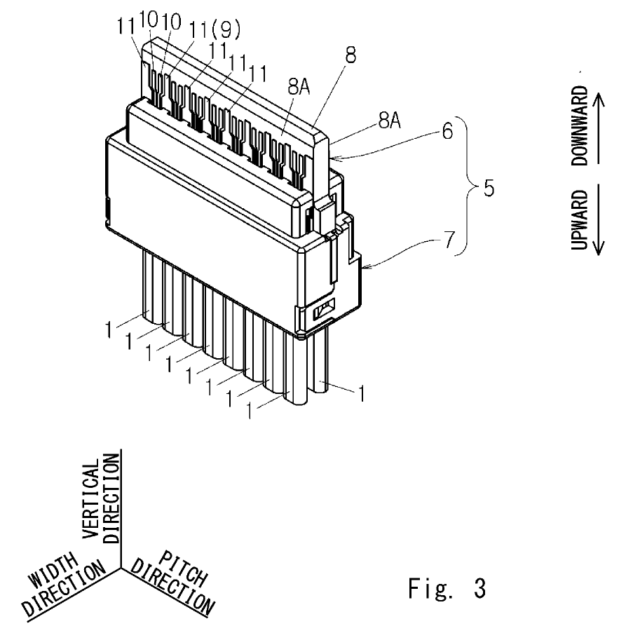

The plug connector 5 will be described hereinafter with reference to FIGS. 1 to 3. FIG. 3 is a perspective view of the plug connector 5. As shown in FIG. 3, the plug connector 5 includes a puddle card 6 and a plug housing 7 that holds the puddle card 6 and the plurality of cables 1.

In the puddle card 6, a plurality of electrode pads 9 are formed on each of two pad formation surfaces 8A of a rigid board 8. On each pad formation surface 8A, the plurality of electrode pads 9 are disposed in a row. Hereinafter, the direction in which the plurality of electrode pads 9 are arranged in a row on each pad formation surface 8A is referred to as a pitch direction. On each pad formation surface 8A, the plurality of electrode pads 9 include a pair of signal pads 10 for differential transmission disposed adjacent to each other and one ground pad 11, which are arranged alternately in the pitch direction.

In each cable 1, an electric wire where a pair of core wires for differential transmission are covered with an insulator is covered with a shield and a sheath in one example. The pair of core wires and the shield of each cable 1 are electrically connected to the pair of signal pads 10 and the ground pad 11, respectively. Typically, on each pad formation surface 8A, the plurality of ground pads 11 are electrically connected with one another.

Referring now to FIGS. 1 to 3, a "vertical direction", a "pitch direction" and a "width direction" will be defined. The vertical direction, the pitch direction, and the width direction are perpendicular to each other.

As shown in FIGS. 1 and 2, the vertical direction is a direction in which the plug connector 5 is inserted into and removed from the receptacle connector 4. Therefore, the vertical direction coincides with the height direction of the receptacle connector 4, and also coincides with the height direction of the plug connector 5. The vertical direction includes an upward direction (a removing direction) and a downward direction (a mating direction). The upward direction is a direction in which the plug connector 5 is removed from the receptacle connector 4. The downward direction is a direction in which the plug connector 5 mates with the receptacle connector 4. The terms "upward" and "downward" are used just for the sake of simplifying the explanation, and do not specify the position of the connector assembly 3 when it is actually used.

As described above, in FIG. 3, the pitch direction is a direction in which the plurality of electrode pads 9 are lined up on the pad formation surfaces 8A of the rigid board 8. The pitch direction includes inward in the pitch direction and outward in the pitch direction. The inward in the pitch direction is a direction toward the center of the connector assembly 3 in the pitch direction. The outward in the pitch direction is a direction receding from the center of the connector assembly 3 in the pitch direction.

The width direction is a direction perpendicular to the vertical direction and the pitch direction. The width direction includes inward in the width direction and outward in the width direction. The inward in the width direction is a direction toward the center of the connector assembly 3 in the width direction. The outward in the width direction is a direction receding from the center of the connector assembly 3 in the width direction.

The "vertical direction", the "pitch direction" and the "width direction" are used also when describing the structure of the receptacle connector 4. As shown in FIG. 1, since the position of the plug connector 5 with respect to the receptacle connector 4 is uniquely determined in the state where the receptacle connector 4 and the plug connector 5 mate with each other, the "pitch direction" and the "width direction" that are defined by referring to the structure of the plug connector 5 can be used in the same way when describing the structure of the receptacle connector 4.

(Receptacle Connector 4)

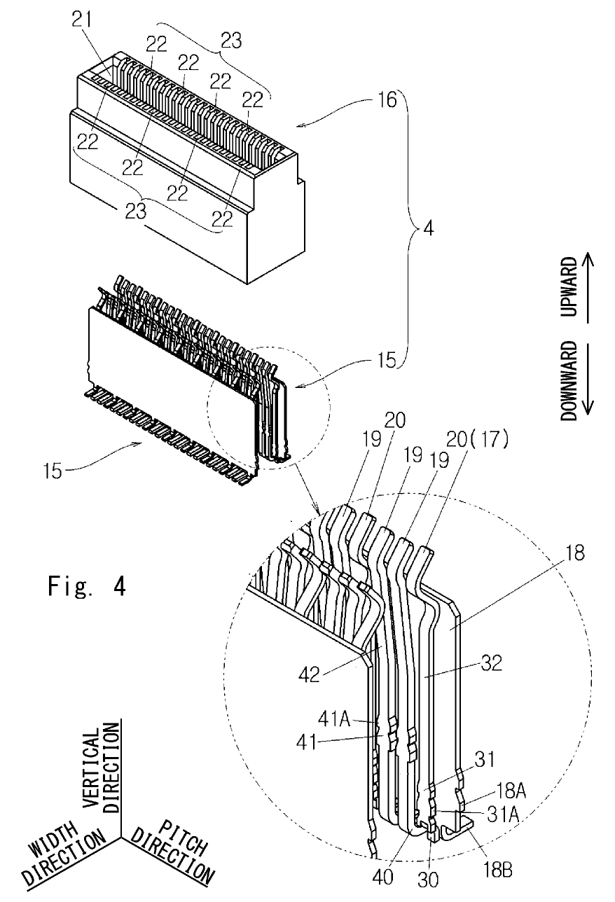

The receptacle connector 4 will be described hereinafter with reference to FIGS. 4 to 6. FIG. 4 is an exploded perspective view of the receptacle connector 4. As shown in FIG. 4, the receptacle connector 4 includes two contact assemblies 15 and a receptacle housing 16 (housing).

The two contact assemblies 15 are formed typically by pressing a sheet metal such as copper or copper alloy. The receptacle housing 16 is formed typically by injection molding an insulating resin such as PBT (Polybutylene Terephthalate), PPS (Poly Phenylene Sulfide), nylon resin, or LCP (Liquid Crystal Polymer; registered trademark).

The two contact assemblies 15 are symmetrical to each other when viewed in the pitch direction. Thus, one of the contact assemblies 15 will be described hereinafter, and description of the other contact assembly 15 will be omitted.

The contact assembly 15 includes a plurality of receptacle contacts 17 (contacts) extending parallel to each other and a ground plate 18 that is disposed opposed to and outward in the width direction relative to the plurality of receptacle contacts 17. The plurality of receptacle contacts 17 extend mainly in the vertical direction. The plurality of receptacle contacts 17 are arranged at regular intervals in the pitch direction. The plurality of receptacle contacts 17 include a pair of signal contacts 19 for differential transmission disposed adjacent to each other and one ground contact 20, which are arranged alternately in the pitch direction. The ground plate 18 is a substantially rectangular flat plate.

The receptacle housing 16 accommodates the two contact assemblies 15. The receptacle housing 16 has a mating space 21 that opens upward so as to accommodate the puddle card 6 of the plug connector 5. The receptacle housing 16 has a plurality of contact slits 22 designed to accommodate the plurality of receptacle contacts 17, respectively. The plurality of contact slits 22 constitute two slit rows 23 extending in the pitch direction. The two slit rows 23 are formed with the mating space 21 interposed therebetween in the width direction. The plurality of contact slits 22 are formed to penetrate the receptacle housing 16 in the vertical direction.

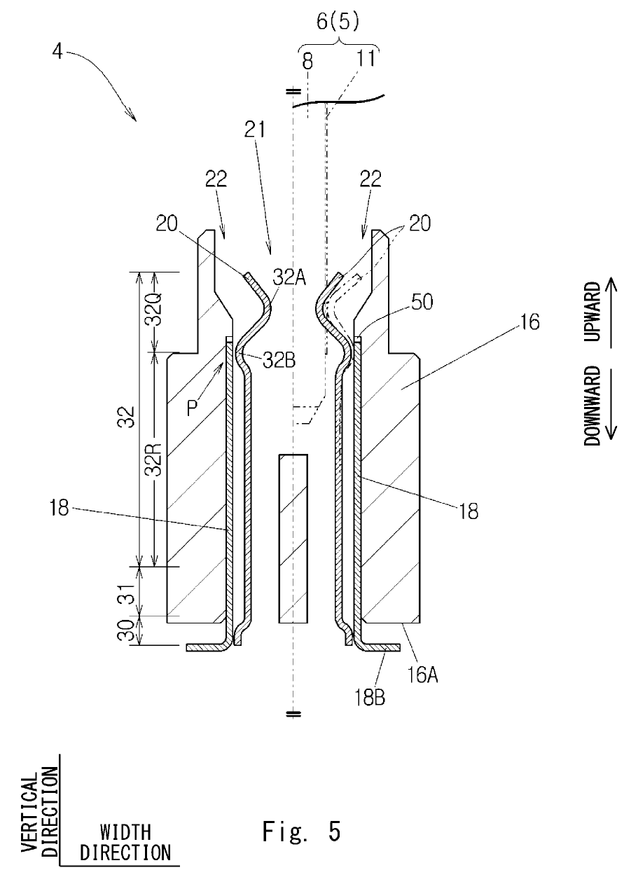

FIG. 5 is an end view of the receptacle connector 4. The end view of FIG. 5 is an illustration in which the ground contact 20 is cut. The left half of FIG. 5 shows an end view of the receptacle connector 4 before the connectors mate, and the right half of FIG. 5 shows an end view of the receptacle connector 4 when the connectors mate. In the right half of FIG. 5, the puddle card 6 of the plug connector 5 is indicated by a chain double-dashed line. Likewise, in the right half of FIG. 5, the ground contact 20 that is elastically deformed by connector mating is indicated by a chain double-dashed line.

As shown in FIGS. 4 and 5, the ground contact 20 extends substantially in the vertical direction as described above. The ground contact 20 includes a soldering part 30, a fixed part 31, and a spring part 32 in this recited order from bottom to top. In FIG. 5, the soldering part 30, the fixed part 31, and the spring part 32 are specified by ranges in the vertical direction for better understanding.

The soldering part 30 projects downward from an undersurface 16A of the receptacle housing 16, and it is to be soldered to the connector mounting surface 2A of the board 2 shown in FIG. 1, together with a soldering part 18B of the ground plate 18, which is described later.

As shown in FIG. 4, the fixed part 31 includes a plurality of press-fitting claws 31A that project in the pitch direction. When the ground contact 20 is press-fit to the contact slit 22 through the undersurface 16A of the receptacle housing 16, the plurality of press-fitting claws 31A bite into an inner surface of the contact slit 22, and thereby the fixed part 31 is fixed to the receptacle housing 16 in such a way that it is substantially not elastically deformable.

As shown in FIG. 5, the spring part 32 is supported like a cantilever beam by the fixed part 31 so that it is elastically deformable. The spring part 32 is elastically deformable inward in the width direction and outward in the width direction, with its fixed end being the upper end of the fixed part 31. The spring part 32 is elastically deformable throughout its length in the vertical direction.

As shown in the right half of FIG. 5, the spring part 32 includes a first contact part 32A that is configured to come into contact with the ground pad 11 of the plug connector 5 when the connectors mate, and a second contact part 32B that comes into contact with the ground plate 18 when the connectors mate.

The first contact part 32A is curved to convex inward in the width direction. The second contact part 32B is curved to convex outward in the width direction. The second contact part 32B is curved to convex toward the ground plate 18. The first contact part 32A is disposed upper than the second contact part 32B. Thus, the second contact part 32B is disposed between the first contact part 32A and the fixed part 31.

The first contact part 32A is not opposed to the ground plate 18 in the width direction. On the other hand, the second contact part 32B is opposed to the ground plate 18 in the width direction.

The spring part 32 includes an upper region 32Q, which is a region upper than a contact position P of the second contact part 32B and the ground plate 18, and a lower region 32R, which is a region lower than the contact position P. Thus, the first contact part 32A is disposed in the upper region 32Q. The second contact part 32B is disposed at the contact position P, which is a boundary between the upper region 32Q and the lower region 32R. In plain terms, the second contact part 32B is disposed in the middle of the spring part 32 in the vertical direction. In other words, the second contact part 32B is disposed at a position away from the upper end of the spring part 32 and is disposed at a position away from the lower end of the spring part 32.

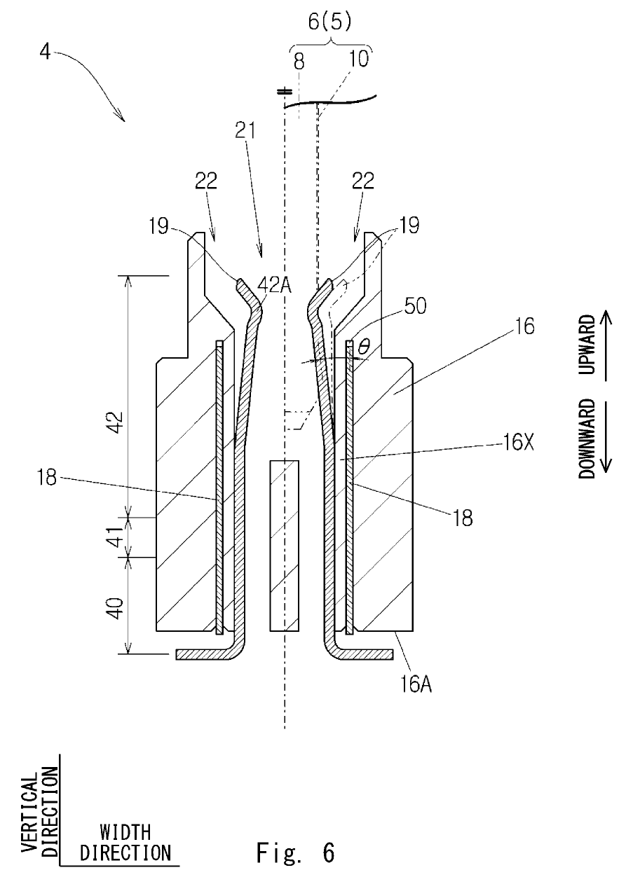

FIG. 6 is an end view of the receptacle connector 4. The end view of FIG. 6 is an illustration in which the signal contact 19 is cut. The left half of FIG. 6 shows an end view of the receptacle connector 4 before the connectors mate, and the right half of FIG. 6 shows an end view of the receptacle connector 4 when the connectors mate. In the right half of FIG. 6, the puddle card 6 of the plug connector 5 is indicated by a chain double-dashed line. Likewise, in the right half of FIG. 6, the signal contact 19 that is elastically deformed by connector mating is indicated by a chain double-dashed line.

As shown in FIGS. 4 and 6, the signal contact 19 extends substantially in the vertical direction as described above. The signal contact 19 includes a soldering part 40, a fixed part 41, and a spring part 42 in this recited order from bottom to top. In FIG. 6, the soldering part 40, the fixed part 41, and the spring part 42 are specified by ranges in the vertical direction for better understanding.

The soldering part 40 projects downward from the undersurface 16A of the receptacle housing 16, and it is to be soldered to the connector mounting surface 2A of the board 2 shown in FIG. 1.

As shown in FIG. 4, the fixed part 41 includes a plurality of press-fitting claws 41A that project in the pitch direction. When the signal contact 19 is press-fit to the contact slit 22 through the undersurface 16A of the receptacle housing 16, the plurality of press-fitting claws 41A bite into the inner surface of the contact slit 22, and thereby the fixed part 41 is fixed to the receptacle housing 16 in such a way that it is substantially not elastically deformable.

As shown in FIG. 6, the spring part 42 is supported like a cantilever beam by the fixed part 41 so that it is elastically deformable. The spring part 42 is elastically deformable inward in the width direction and outward in the width direction, with its fixed end being the upper end of the fixed part 41. The spring part 42 is elastically deformable throughout its length in the vertical direction.

As shown in the right half of FIG. 6, the spring part 42 includes a first contact part 42A that is configured to come into contact with the signal pad 10 of the plug connector 5 when the connectors mate.

The first contact part 42A is curved to convex inward in the width direction.

The first contact part 42A is not opposed to the ground plate 18 in the width direction.

As shown in FIGS. 4 to 6, the spring part 42 of the signal contact 19 and the spring part 32 of the ground contact 20 that are adjacent to each other in the pitch direction are elastically deformable independently of each other. This ensures high contact reliability between the plurality of receptacle contacts 17 of the receptacle connector 4 and the plurality of electrode pads 9 of the plug connector 5.

As described above, the ground plate 18 is a rectangular flat plate. To be specific, as shown in FIG. 4, the ground plate 18 does not have a slit between the spring part 42 of the signal contact 19 and the spring part 32 of the ground contact 20 when viewed in the width direction. Moreover, the ground plate 18 does not have a slit between the signal contact 19 and the ground contact 20 when viewed in the width direction.

As shown in FIGS. 5 and 6, the ground plate 18 is accommodated in a plate slit 50 that is formed in the receptacle housing 16. As shown in FIG. 4, a plurality of press-fitting claws 18A are formed at both ends in the pitch direction of the ground plate 18. When the ground plate 18 is press-fit to the plate slit 50 through the undersurface 16A of the receptacle housing 16, the plurality of press-fitting claws 18A bite into an inner surface of the plate slit 50, and thereby the ground plate 18 is fixed to the receptacle housing 16 in such a way that it is substantially not elastically deformable.

As shown in FIGS. 4 and 5, a plurality of soldering parts 18B are formed at the lower end of the ground plate 18. The plurality of soldering parts 18B project downward from the undersurface 16A of the receptacle housing 16, and they are to be soldered to the connector mounting surface 2A of the board 2 shown in FIG. 1.

As shown in FIG. 5, the ground plate 18 extends in the vertical direction from the undersurface 16A of the receptacle housing 16 up to the contact position P. As shown in the right half of FIG. 5, when the connectors mate, the ground plate 18 is electrically connected with the ground pad 11 of the puddle card 6 of the plug connector 5 sequentially through the second contact part 32B and the first contact part 32A of the ground contact 20.

As shown in FIG. 6, a thin part of the receptacle housing 16 is interposed between the signal contact 19 and the ground plate 18 in the width direction. The thin part of the receptacle housing 16 that is interposed between the signal contact 19 and the ground plate 18 is referred to as a dielectric layer 16X. Thus, the signal contact 19, the dielectric layer 16X, and the ground plate 18 constitute a microstrip line.

The technical significance of the second contact part 32B will be described hereinafter. In FIG. 5, if the ground contact 20 does not exist, i.e., the ground contact 20 is not in contact with the ground plate 18 at the contact position P, the ground plate 18 is electrically connected with the ground pad 11 of the puddle card 6 of the plug connector 5 sequentially through the plurality of soldering parts 18B, the connector mounting surface 2A of the board 2, and the soldering part 30, the fixed part 31, and the spring part 32 of the plurality of ground contacts 20. In this manner, the ground plate 18 is electrically connected with the ground pad 11 of the puddle card 6 of the plug connector 5 through an extremely indirect route that goes through the board 2. Thus, the electromagnetic coupling between the signal contact 19 and the ground plate 18 is weak, and thereby high-frequency performance as a microstrip line is not achievable.

On the other hand, in this embodiment, the ground plate 18 is electrically connected with the ground pad 11 of the puddle card 6 of the plug connector 5 sequentially through the second contact part 32B and the first contact part 32A of the ground contact 20 as described above. In this manner, the ground plate 18 is electrically connected with the ground pad 11 of the puddle card 6 of the plug connector 5 through the shortest route without going a long way round. Thus, the electromagnetic coupling between the signal contact 19 and the ground plate 18 is strong, and thereby high-frequency performance as a microstrip line is achievable. Significantly, in FIG. 5, a microstrip line that exhibits high-frequency performance is formed even in the lower region 32R in which the ground contact 20 has high springiness. Therefore, the contact reliability and the high-frequency performance are achievable at the same time in the receptacle connector 4.

Moreover, as shown in the right half of FIG. 6, when viewed in the pitch direction, an angle θ between the longitudinal direction of the spring part 42 of the signal contact 19 and the ground plate 18 decreases by connector mating. In other words, as shown in the right half of FIG. 6, when viewed in the pitch direction, the longitudinal direction of the spring part 42 of the signal contact 19 and the ground plate 18 come nearly parallel to each other by connector mating. Thus, when the connectors mate, the distance between the signal contact 19 and the ground plate 18 is substantially constant throughout the whole range in the vertical direction, so that the high-frequency performance of the microstrip line that is made of the signal contact 19, the dielectric layer 16X, and the ground plate 18 is achieved at high level.

The first embodiment of the present disclosure is described above. The above-described first embodiment has the following features.

As shown in FIGS. 1 to 6, the receptacle connector 4 includes the plurality of receptacle contacts 17 (contacts) extending parallel to each other, the ground plate 18 disposed opposed to the plurality of receptacle contacts 17, and the receptacle housing 16 (housing) that accommodates the plurality of receptacle contacts 17 and the ground plate 18. The receptacle connector 4 is mounted for use on the connector mounting surface 2A of the board 2. Each receptacle contact 17 includes the soldering part (30, 40) to be soldered to the connector mounting surface 2A of the board 2, the fixed part (31, 41) to be fixed to the receptacle housing 16, and the spring part (32, 42) supported like a cantilever beam by the fixed part (31, 41) and elastically deformable in this recited order. The spring part (32, 42) includes the first contact part (32A, 42A) configured to come into contact with the plug connector 5. The plurality of receptacle contacts 17 include the signal contacts 19 adjacent to each other and the ground contact 20. The spring part 42 of the signal contact 19 and the spring part 32 of the ground contact 20 are elastically deformable independently of each other. The spring part 32 of the ground contact 20 further includes the second contact part 32B that comes into contact with the ground plate 18 when the connectors mate. In this structure, the contact reliability and the high-frequency performance are achievable at the same time.

Note that, in the above-described first embodiment, the second contact part 32B of the spring part 32 of the ground contact 20 comes into contact with the ground plate 18 by connector mating. Alternatively, however, the second contact part 32B of the spring part 32 of the ground contact 20 may be already in contact with the ground plate 18 before the connectors mate. In any case, the lower region 32R, particularly, of the spring part 32 is elastically deformable with no problem, which ensures the high contact reliability of the receptacle connector 4.

Further, as shown in FIG. 5, the second contact part 32B is disposed between the first contact part 32A and the fixed part 31. In this structure, compared with the case where the second contact part 32B is disposed upper than the first contact part 32A, the ground plate 18 is able to be electrically connected with the ground pad 11 of the puddle card 6 of the plug connector 5 through the shortest route without going a long way round, which contributes to the high-frequency performance of the microstrip line.

Further, as shown in FIG. 5, the ground plate 18 is electrically connected with the ground pad 11 of the puddle card 6 of the plug connector 5 sequentially through the second contact part 32B and the first contact part 32A of the ground contact 20 when the connectors mate or already before the connectors mate. In this structure, the ground plate 18 is able to be electrically connected with the ground pad 11 of the puddle card 6 of the plug connector 5 through a route that is suitable for achieving the high-frequency performance of the microstrip line.

Further, as shown in FIG. 4, the ground plate 18 does not have a slit between the spring part 42 of the signal contact 19 and the spring part 32 of the ground contact 20. In plain terms, the ground plate 18 does not have a slit between the signal contact 19 and the ground contact 20. In this structure, a part of the ground plate 18 that is electromagnetically coupled to the signal contact 19 is able to be electrically connected with the ground pad 11 of the puddle card 6 of the plug connector 5 through the shortest route without going a long way round.

Further, as shown in FIG. 4, the ground plate 18 is a rectangular flat plate in one example. In this structure, the ground plate 18 is manufactured at low costs.

Further, as shown in FIG. 6, the angle θ between the longitudinal direction of the spring part 42 of the signal contact 19 and the ground plate 18 decreases by connector mating. In this structure, when the connectors mate, the distance between the signal contact 19 and the ground plate 18 is substantially constant throughout the whole range in the vertical direction, so that the high-frequency performance of the microstrip line made of the signal contact 19, the dielectric layer 16X, and the ground plate 18 is achieved at high level.

Further, as shown in FIG. 5, the ground contact 20 and the ground plate 18 are separately formed. This structure allows easy manufacturing of the ground contact 20 and the ground plate 18, which increases the design flexibility of the ground contact 20 and the ground plate 18.

### (Second Embodiment)

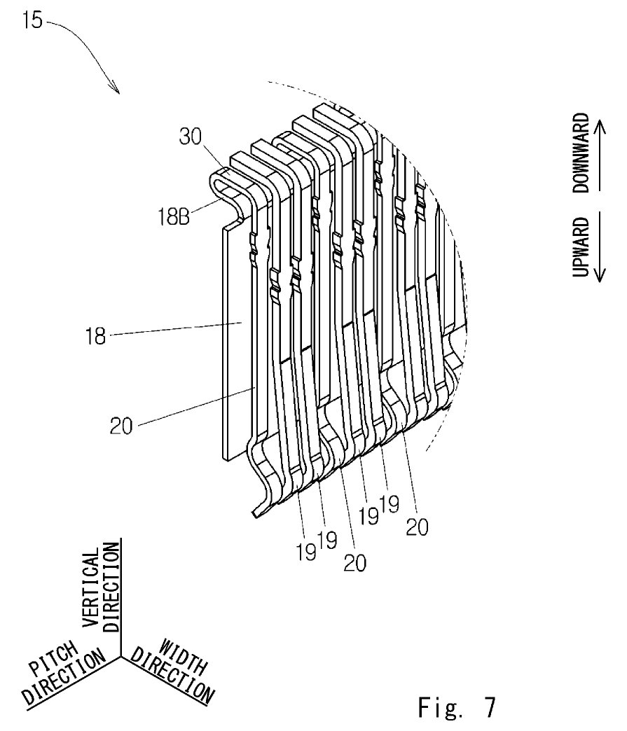

A second embodiment of the present disclosure will be described hereinafter with reference to FIG. 7. Hereinafter, differences of this embodiment from the above-described first embodiment are mainly described, and redundant description is omitted. FIG. 7 is a perspective view of the contact assembly 15 of the receptacle connector 4.

In the above-described first embodiment, as shown in FIG. 5, the ground contact 20 and the ground plate 18 are separately formed. On the other hand, in this embodiment, as shown in FIG. 7, the ground contact 20 and the ground plate 18 are integrally formed. To be specific, the soldering part 30 of the ground contact 20 and the soldering part 18B of the ground plate 18 are coupled to each other. In this structure, the number of parts is reduced compared with the case where the ground contact 20 and the ground plate 18 are separately formed.

### (Third Embodiment)

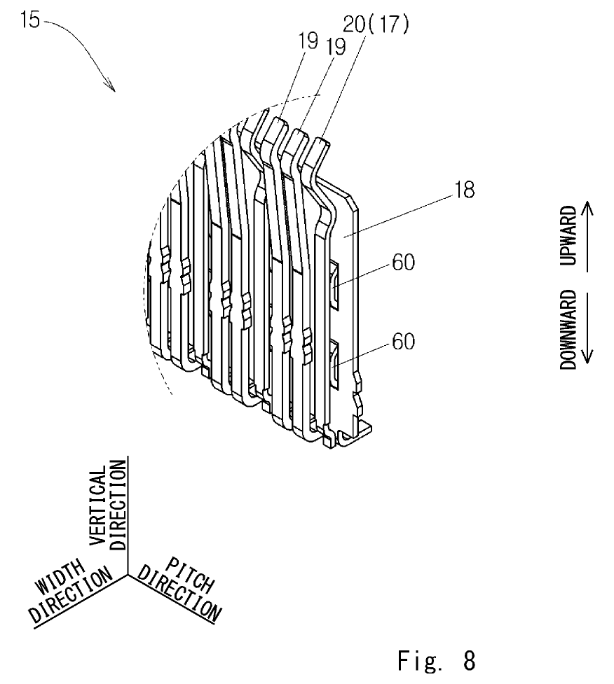

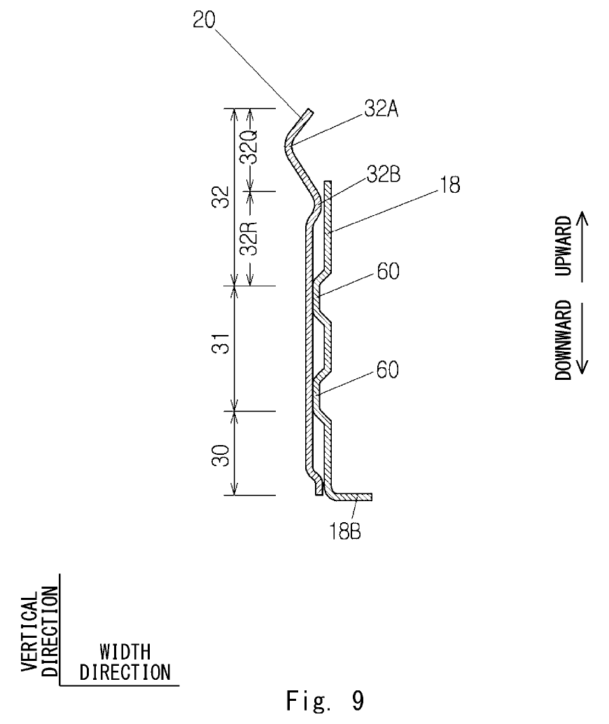

A third embodiment of the present disclosure will be described hereinafter with reference to FIGS. 8 and 9. Hereinafter, differences of this embodiment from the earlier-described first embodiment are mainly described, and redundant description is omitted. FIG. 8 is a perspective view of the contact assembly 15 of the receptacle connector 4. FIG. 9 is an end view of the contact assembly 15. The end view of FIG. 9 is an illustration in which the ground contact 20 is cut.

As shown in FIGS. 8 and 9, in this embodiment, the ground contact 20 is supported by the ground plate 18 by welding. To be specific, on the ground plate 18, a plurality of projecting parts 60 that project toward the ground contact 20 are formed for each ground contact 20. The plurality of projecting parts 60 include two projecting parts 60 in this embodiment. The two projecting parts 60 are disposed opposed to one ground contact 20 in the width direction. The two projecting parts 60 are disposed at a distance from each other in the vertical direction. The ground contact 20 is welded to the two projecting parts 60. The ground contact 20 is thereby fixed to the ground plate 18. In other words, the fixed part 31 of the ground contact 20 is welded to the two projecting parts 60 and thereby fixed to the ground plate 18 in such a way that it is substantially not elastically deformable. As a result, the fixed part 31 of the ground contact 20 is fixed to the receptacle housing 16 in such a way that it is substantially not elastically deformable through the ground plate 18 including the two projecting parts 60. In this manner, since the fixed part 31 of the ground contact 20 is electrically connected with the ground plate 18 through the two projecting parts 60, the electromagnetic coupling between the signal contact 19 and the ground plate 18 is enhanced, and thereby the high-frequency performance of the receptacle connector 4 is achieved. Further, as shown in FIG. 9, since the fixed part 31 of the ground contact 20 is electrically connected with the ground plate 18 at a plurality of points in the vertical direction, the electromagnetic coupling between the signal contact 19 and the ground plate 18 is more enhanced, and thereby the high-frequency performance of the receptacle connector 4 is achieved at higher level.

The third embodiment of the present disclosure is described above. The above-described third embodiment has the following features.

Specifically, as shown in FIGS. 8 to 9, on the ground plate 18, the two projecting parts 60 that project toward the ground contact 20 are formed for each ground contact 20. The fixed part 31 of the ground contact 20 is welded to the corresponding two projecting parts 60. In this structure, the electromagnetic coupling between the signal contact 19 and the ground plate 18 is more enhanced, and thereby the high-frequency performance of the receptacle connector 4 is achieved at higher level.

Note that, in the above-described description of the third embodiment, two projecting parts 60 that project toward the ground contact 20 are formed for each ground contact 20 on the ground plate 18. Alternatively, however, only one projecting part 60 that projects toward the ground contact 20, or three or more projecting parts 60 that project toward the ground contact 20, may be formed for each ground contact 20 on the ground plate 18.

In this embodiment, as shown in FIG. 9, the length of the spring part 32 in the vertical direction is reduced compared with the first embodiment described earlier. However, this embodiment is the same as the earlier-described first embodiment in that the second contact part 32B is disposed in the middle of the spring part 32 and that the lower region 32R is elastically deformable.

Note that the ground contact 20 may be welded to the two projecting parts 60 by fusion welding, pressure welding, brazing and soldering or the like, for example. The fusion welding is a process that joins materials by melting base materials or melting a base material and a welding rod (filler metal) for joining the base material. The pressure welding is a process that joins materials by melting a base material mechanically by way of friction, pressure, current or the like. The brazing and soldering are processes that use a filler metal (brazing filler metal) to join metal pieces.

### (Fourth Embodiment)

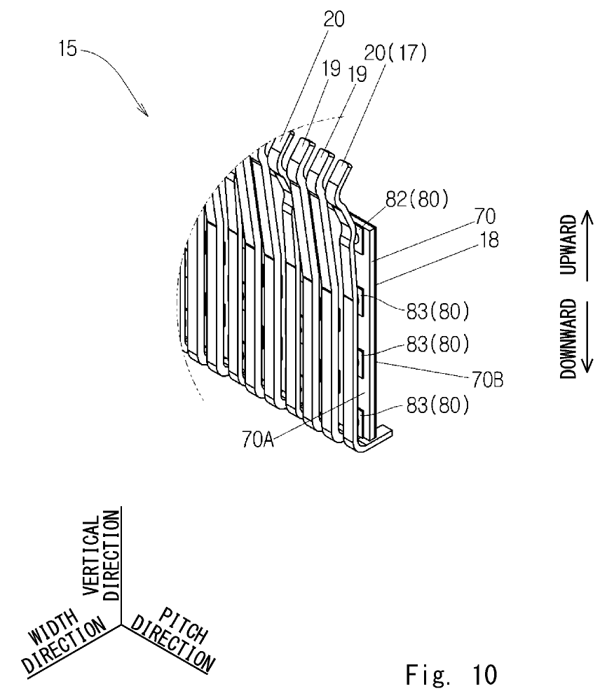

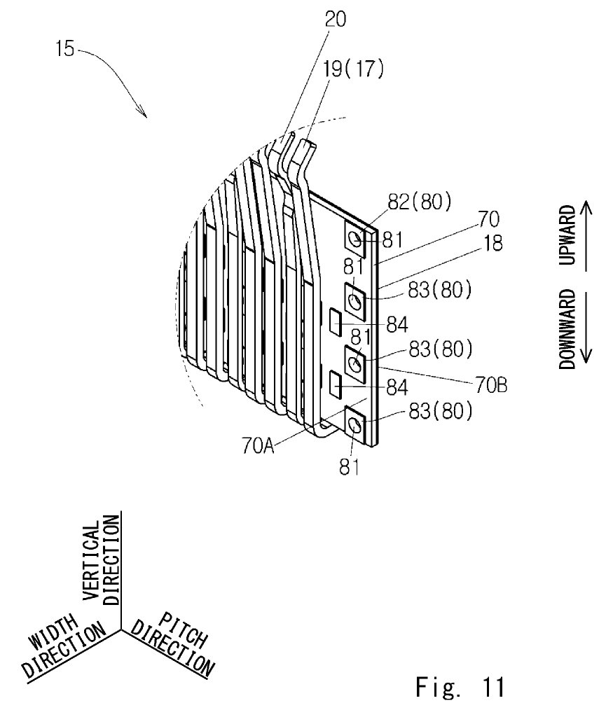

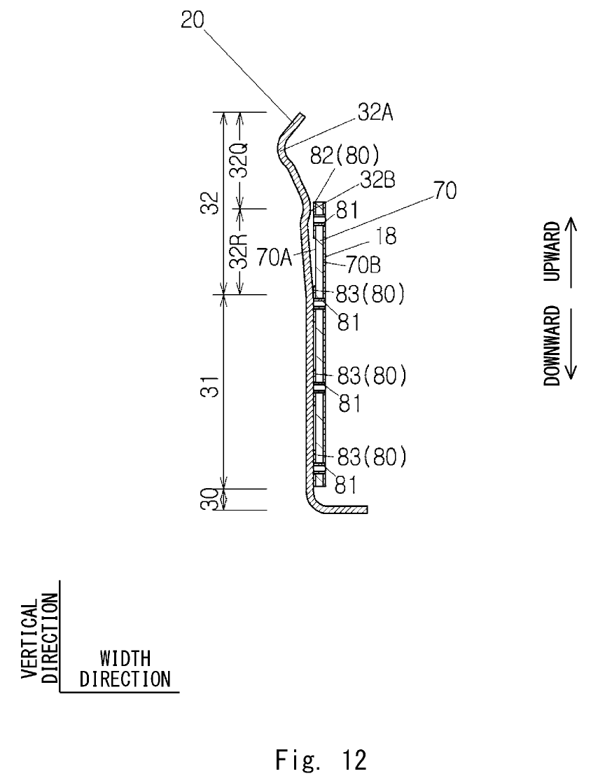

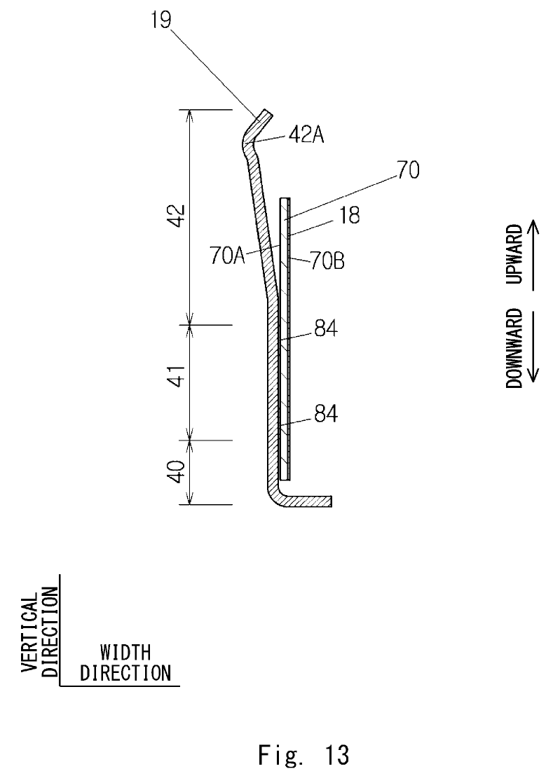

A fourth embodiment of the present disclosure will be described hereinafter with reference to FIGS. 10 to 13. Hereinafter, differences of this embodiment from the earlier-described first embodiment are mainly described, and redundant description is omitted. FIGS. 10 and 11 are perspective views of the contact assembly 15. In FIG. 11, several receptacle contacts 17 among the plurality of receptacle contacts 17 are not shown for the sake of simplifying the explanation. FIGS. 12 and 13 are end views of the contact assembly 15. The end view of FIG. 12 is an illustration in which the ground contact 20 is cut. The end view of FIG. 13 is an illustration in which the signal contact 19 is cut.

As shown in FIGS. 10 and 13, the contact assembly 15 includes a plurality of receptacle contacts 17, a rigid board 70, and a ground plate 18 outward in the width direction in this recited order. Just like in the earlier-described first embodiment, the ground plate 18 is disposed opposed to the plurality of receptacle contacts 17 in the width direction. The rigid board 70 is disposed between the plurality of receptacle contacts 17 and the ground plate 18. The contact assembly 15 is accommodated in the receptacle housing 16, just like in the earlier-described first embodiment.

The rigid board 70 includes a contact surface 70A facing the plurality of receptacle contacts 17 and a ground surface 70B facing the ground plate 18. The plurality of receptacle contacts 17 are fixed to the contact surface 70A. The ground plate 18 is formed as a solid pattern on the ground surface 70B.

As shown in FIGS. 11 and 12, a plurality of pads 80 are formed for each ground contact 20 on the contact surface 70A of the rigid board 70. The plurality of pads 80 are aligned in the vertical direction. Typically, the plurality of pads 80 are arranged at certain intervals in the vertical direction. Each pad 80 is electrically connected with the ground plate 18 via a through-hole 81.

The plurality of pads 80 include one contact pad 82 that is opposed to the second contact part 32B of the spring part 32 of the corresponding ground contact 20 in the width direction and three fixed pads 83 that are opposed to the fixed part 31 of the corresponding ground contact 20 in the width direction.

The second contact part 32B of the spring part 32 of the ground contact 20 is configured to come into contact with the corresponding contact pad 82 when the connectors mate. The second contact part 32B of the spring part 32 of the ground contact 20 may be in contact with the corresponding contact pad 82 already before the connectors mate, just like in the earlier-described first embodiment.

The fixed part 31 of the ground contact 20 is soldered to the three fixed pads 83. The ground contact 20 is thereby fixed to the contact surface 70A of the rigid board 70. When the connectors mate, the ground contact 20 is electrically connected with the ground plate 18 through the plurality of pads 80 including the one contact pad 82 and the three fixed pads 83. Consequently, the electromagnetic coupling between the signal contact 19 and the ground plate 18 is enhanced, and thereby the high-frequency performance of the receptacle connector 4 is achieved.

As shown in FIGS. 11 to 13, a plurality of fixed pads 84 are formed for each signal contact 19 on the contact surface 70A of the rigid board 70. In this embodiment, the plurality of fixed pads 84 include two fixed pads 84. The two fixed pads 84 are disposed opposed to the corresponding signal contact 19 in the width direction. The two fixed pads 84 are disposed at a distance from each other in the vertical direction. The signal contact 19 is soldered to the two fixed pads 84. The signal contact 19 is thereby fixed to the contact surface 70A of the rigid board 70. To be specific, the fixed part 41 of the signal contact 19 is soldered to the two fixed pads 84 and thereby fixed to the contact surface 70A of the rigid board 70 in such a way that it is substantially not elastically deformable.

Note that the rigid board 70 is typically press-fit to the above-described plate slit 50 together with the ground plate 18 and thereby accommodated and held in the receptacle housing 16. Further, the ground plate 18 is electrically connected to the connector mounting surface 2A of the board 2 through the plurality of ground contacts 20. The plurality of receptacle contacts 17 are held in the receptacle housing 16 through the ground plate 18.

The fourth embodiment of the present disclosure is described above. The above-described fourth embodiment has the following features.

The receptacle connector 4 includes the plurality of receptacle contacts 17 (contacts) extending parallel to each other, the ground plate 18 disposed opposed to the plurality of receptacle contacts 17, the rigid board 70 disposed between the plurality of receptacle contacts 17 and the ground plate 18, and the receptacle housing 16 that accommodates the plurality of receptacle contacts 17, the ground plate 18, and the rigid board 70. The receptacle connector 4 is mounted for use on the connector mounting surface 2A of the board 2. The rigid board 70 includes the contact surface 70A facing the plurality of receptacle contacts 17 and the ground surface 70B facing the ground plate 18. The ground plate 18 is formed as a solid pattern on the ground surface 70B of the rigid board 70. Each receptacle contact 17 includes the soldering part (30, 40) to be soldered to the connector mounting surface 2A of the board 2, the fixed part (31, 41) to be fixed to the contact surface 70A of the rigid board 70, and the spring part (32, 42) supported like a cantilever beam by the fixed part (31, 41) and elastically deformable in this recited order. The spring part (32, 42) includes the first contact part (32A, 42A) configured to come into contact with the plug connector 5. The plurality of receptacle contacts 17 include the signal contacts 19 adjacent to each other and the ground contact 20. The spring part 42 of the signal contact 19 and the spring part 32 of the ground contact 20 are elastically deformable independently of each other. The spring part 32 of the ground contact 20 further includes the second contact part 32B that comes into contact with the contact pad 82 formed on the contact surface 70A of the rigid board 70 when the connectors mate. The contact pad 82 is electrically connected with the ground plate 18 via the through-hole 81. In this structure, just like in the earlier-described first embodiment, the contact reliability and the high-frequency performance are achievable at the same time. Further, since the rigid board 70 serves as the dielectric layer 16X interposed between the receptacle contact 17 and the ground plate 18, the dielectric layer 16X is thinner compared with the first embodiment in which this dielectric layer is formed by injection molding.

Note that the second contact part 32B of the spring part 32 of the ground contact 20 may be in contact with the contact pad 82 formed on the contact surface 70A of the rigid board 70 already before the connectors mate.

Further, a plurality of fixed pads 83 that are electrically connected with the ground plate 18 via the through-hole 81 are formed on the contact surface 70A of the rigid board 70. The fixed part 31 of the ground contact 20 is soldered to the plurality of fixed pads 83. In this structure, the electromagnetic coupling between the signal contact 19 and the ground plate 18 is enhanced, and thereby the high-frequency performance of the receptacle connector 4 is achieved.

Note that, in the description of the above-described fourth embodiment, the three fixed pads 83 that are opposed to the ground contact 20 are formed for each ground contact 20 on the contact surface 70A of the rigid board 70. Alternatively, however, only one fixed pad 83 that is opposed to the ground contact 20, or three or more fixed pads 83 that are opposed to the ground contact 20, may be formed for each ground contact 20 on the contact surface 70A of the rigid board 70.

Although the embodiments of the disclosure made by the present inventor are described in the foregoing, the present disclosure is not restricted to the above-described embodiments, and various changes and modifications may be made without departing from the scope of the invention.

The first to forth embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A receptacle connector to be mounted on a board, comprising:
a plurality of contacts extending parallel to each other;
a ground plate disposed opposed to the plurality of contacts; and
a housing that accommodates the plurality of contacts and the ground plate, wherein
each of the plurality of contacts includes, in the following recited order:
a soldering part to be soldered to the board;
a fixed part to be fixed to the housing; and
a spring part supported like a cantilever beam by the fixed part and elastically deformable,
the spring part includes a first contact part configured to come into contact with a plug connector,
the plurality of contacts include a signal contact and a ground contact adjacent to each other,
the spring part of the signal contact and the spring part of the ground contact are elastically deformable independently of each other, and
the spring part of the ground contact further includes a second contact part that comes into contact with the ground plate when the connectors mate or is in contact with the ground plate already before the connectors mate.

2. The receptacle connector according to claim 1, wherein the second contact part is disposed between the first contact part and the fixed part.

3. The receptacle connector according to claim 1, wherein the ground plate is electrically connected with the plug connector sequentially through the second contact part and the first contact part of the ground contact when the connectors mate or already before the connectors mate.

4. The receptacle connector according to claim 1, wherein the ground plate does not have a slit between the spring part of the signal contact and the spring part of the ground contact.

5. The receptacle connector according to claim 1, wherein the ground plate does not have a slit between the signal contact and the ground contact.

6. The receptacle connector according to claim 1, wherein the ground plate is a rectangular flat plate.

7. The receptacle connector according to claim 1, wherein an angle between a longitudinal direction of the spring part of the signal contact and the ground plate decreases by mating of the connectors.

8. The receptacle connector according to claim 1, wherein the ground contact and the ground plate are separately formed.

9. The receptacle connector according to claim 1, wherein the ground contact and the ground plate are integrally formed.

10. The receptacle connector according to claim 1, wherein
at least one projecting part projecting toward the ground contact is formed on the ground plate, and
the fixed part of the ground contact is welded to the at least one projecting part.

11. The receptacle connector according to claim 10, wherein the at least one projecting part includes a plurality of projecting parts.

12. A receptacle connector to be mounted on a board, comprising:
a plurality of contacts extending parallel to each other;
a ground plate disposed opposed to the plurality of contacts;
a rigid board disposed between the plurality of contacts and the ground plate; and
a housing that accommodates the plurality of contacts, the ground plate, and the rigid board, wherein
the rigid board includes a contact surface facing the plurality of contacts and a ground surface facing the ground plate,
the ground plate is formed as a solid pattern on the ground surface,
each of the plurality of contacts includes, in the following recited order:
a soldering part to be soldered to the board;
a fixed part to be fixed to the rigid board; and
a spring part supported like a cantilever beam by the fixed part and elastically deformable,
the spring part includes a first contact part configured to come into contact with a plug connector,
the plurality of contacts include a signal contact and a ground contact adjacent to each other,
the spring part of the signal contact and the spring part of the ground contact are elastically deformable independently of each other,
the spring part of the ground contact further includes a second contact part that comes into contact with a contact pad formed on the contact surface when the connectors mate or is in contact with the contact pad already before the connectors mate, and
the contact pad is electrically connected with the ground plate via a through-hole.

13. The receptacle connector according to claim 12, wherein
at least one fixed pad that is electrically connected with the ground plate via a through-hole is formed on the contact surface of the rigid board, and
the fixed part of the ground contact is soldered to the at least one fixed pad.

14. The receptacle connector according to claim 13, wherein the at least one fixed pad includes a plurality of fixed pads.

15. The receptacle connector according to claim 1, wherein the plurality of contacts include a pair of signal contacts for differential transmission disposed adjacent to each other and one ground contact, alternately in a pitch direction of the plurality of contacts.

16. The receptacle connector according to claim 12, wherein the plurality of contacts include a pair of signal contacts for differential transmission disposed adjacent to each other and one ground contact, alternately in a pitch direction of the plurality of contacts.
